(19) United States
(12) Patent Application Publication
(10) Pub. No.: US 2006/0236319 A1
(43) Pub. Date: Oct. 19, 2006

(54) Version control system

(75) Inventors: Justin E. Pinnix, Raleigh, NC (US); Brian David Harry, Chapel Hill, NC (US); Michael V. Sliger, Sammamish, WA (US); Christopher Antos, Redmond, WA (US); Thomas D. McGuire, Georgetown, TX (US)

Correspondence Address: WOLF GREENFIELD (Microsoft Corporation);C/O WOLF, GREENFIELD & SACKS, P.C., FEDERAL RESERVE PLAZA, 600 ATLANTIC AVENUE, BOSTON, MA, 02210-2206, US

(73) Assignee: Microsoft Corporation, Redmond, WA (US)

(21) Appl. No.: 11/107,145

(22) Filed: Apr. 15, 2005

(51) Int. Cl. G06F 9/44

(52) U.S. Cl. 717/170

(57) ABSTRACT

A version control system such as may be used in an information management system for a source code development project. Multiple versions of artifacts are stored in the version control system. Some versions are stored in uncompressed form while others are stored in compressed form. The artifacts selected to be stored in compressed form are selected to facilitate rapid retrieval of files. The compression process is such that the compression may be performed as a background operation.

### BACKGROUND OF INVENTION

1. Field of Invention

The invention relates generally to information management systems and more particularly to data compression techniques used in information management systems.

2. Discussion of Related Art

Information management systems are widely used to store information in electronic form. Such a system is important, for example, in an enterprise where multiple people must access electronic information for various tasks.

Information management systems generally operate on “artifacts.” An artifact is an object containing information. A common example of an artifact is a file in a computerized storage system.

One class of information management system is a version control system. As each artifact is modified, a new version of the artifact may be saved by the version control system. Frequently, people in the enterprise will access only the most recent version of the artifact. However, prior versions of the artifact may sometimes be required, and the version control system retains prior versions of the artifacts so that any desired version may be retrieved.

For example, a version control system may store files representing source code for a relatively large products, which may be released in multiple revision levels. When one revision of the product is released, the most recent version of some files may have new features that have not been tested or debugged. Accordingly, when that revision of the product is built, prior versions of some files, representing the last version that was fully tested and debugged, may be incorporated into the product. Also, support and maintenance of a revision of the product that was previously released may require access to old versions of a file. Accordingly, many versions of a file may be saved and retrieved for any number of reasons.

A drawback of saving many versions of the files in a version control system is that large amounts of computer storage is required to store all of the files. To ameliorate this problem, many version control systems incorporate compression algorithms. In cases where the files represent lines of text, each line of text may be identified by an end of line character, such as by a carriage return character at the end of each line. Lines in an older version of a file can be compared to corresponding lines in a newer version of the file. Any lines that are the same in both versions need not be stored. Rather, the system may store a “pointer” to the corresponding line in a file that has already been saved.

The approach of storing only a pointer to unchanged “lines” has been used in version control systems that store binary files. Strings of bits often found at the end of segments in the binary file were treated as the end of a line character.

File compression is also used in other applications, such as in sending “patches” for software. The “patch” is a compressed file describing changes to a prior version of a file to make corrections to the file. Examples of data compression used in forming a “patch” may be found in U.S. Pat. Nos. 6,496,974; 6,466,999; 6,449,764; 6,243,766; and 6,216,175.

### SUMMARY OF INVENTION

A version control system in which multiple versions of artifacts may be stored, with some being compressed and others being used as a basis for uncompression.

In one aspect, the invention relates to a method of operating a version control system storing a plurality of versions of an artifact including at least a first version of the artifact and a second version of the artifact, each of the first version and the second version comprising strings of data. The method comprises forming a compressed representation of the first version of the artifact by: forming a compression dictionary comprising strings of data from the first version of the artifact and the second version of the artifact; for each of a plurality of strings of data in the first version of the artifact, matching the string of data to a matching string of data in the compression dictionary; for each string of data in the first version of the artifact matched to a matching string of data in the compression dictionary, including in the compressed representation an indication of the matching string of data. The method also includes storing the second version of the artifact and the compressed representation of the first version.

In a further aspect, the invention relates to a method of operating a version control system storing representations of a plurality of files, including a text file that has a format defining line of text and a binary file, with the version control system storing at least a first version of the text file and a second version of the text file and a first version of the binary file and second version of the binary file. The method comprises forming a compressed representation of the first version of the text file using a predetermined compression process that is independent of the format of data in the first version of the text file; forming a compressed representation of the first version of the binary file using the predetermined compression process; and storing the compressed representation of the first version of the binary file and the compressed representation of the first version of the text file.

In a further aspect, the invention relates to a version control system for storing a plurality of successive versions of an artifact, the version control system having computer-readable medium having stored thereon data structures. The data structures hold a compressed representation of each of a first portion of the plurality of successively created versions of the artifact, the compressed representation comprising, for each version of the first portion of the plurality of successively created versions, indications of entries in a compression dictionary, the compression dictionary including at least a portion of the version and at least a portion of a successive version; a first uncompressed representation of a first selected version, the first selected version succeeding the first portion of the plurality of successively created versions; a compressed representation of a second portion of the plurality of successively created versions of the artifact, the second portion succeeding the first version of the first portion of the plurality of successively created versions, the compressed representations comprising, for each version of the second portion of the plurality of successively created versions, indications of entries in a compression dictionary including at least a portion of the version and at least a portion of the successive version; and a second uncompressed representation of a selected version, the second selected version succeeding the second portion of the plurality of successively created versions.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a version control system;

FIG. 2 is a sketch illustrating the organization of a database in the version control system of FIG. 1;

FIG. 3 is a sketch illustrating the organization of a database in a version control system according to one embodiment of the invention;

FIG. 4A is a sketch illustrating a compression process according to one embodiment of the invention;

FIG. 4B is a sketch illustrating the compression process of FIG. 4A at a later stage in the process;

FIG. 5A is a flowchart of a process for storing a version of a file according to an embodiment of the invention; and

FIG. 5B is a flowchart of a process for retrieving a version of a file according to an embodiment of the invention.

### DETAILED DESCRIPTION

A version control system uses an efficient compression process for storing prior versions of artifacts. The compression process produces a compressed artifact that contains a list of references to strings of characters in the same artifact or another artifact that is available to the version control system. A successive version of the same artifact may be used for compressing a version of an artifact.

As each successive version of an artifact is stored, the prior version may be compressed in a background process. Because the version control system does not rely on finding differences between lines or similar structures in files, it may be used in connection with multiple types of artifacts, including text and binary files.

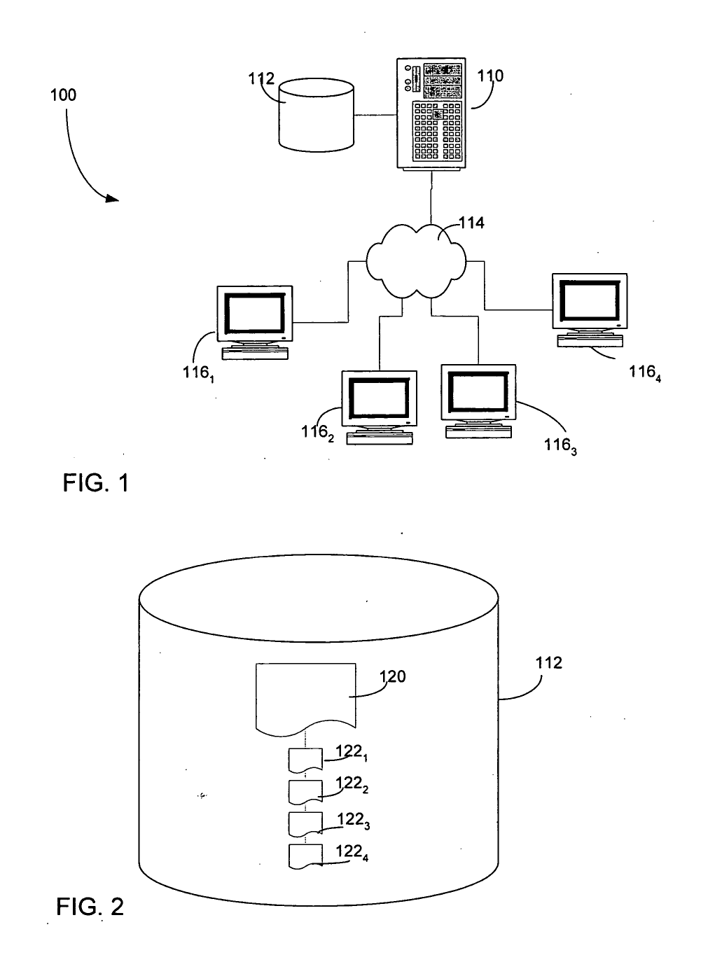

FIG. 1 shows an example of a version control system 100. Version control system 100 includes a database 112 in which artifacts are stored. Database 112 may be implemented in a computer-readable medium or in any suitable fashion. For example, database 112 may be hardware and associated storage management software as is now known in the art or may be hereafter developed. Information in database 112 may be organized to facilitate storage and retrieval of artifacts in either compressed or uncompressed form.

A version control system used in a software development environment is used as an example of a version control system. In this embodiment, the artifacts are files. They may be text files, containing specifications, source code, or development plans or other documentation relating to the software under development. Such a version control system may also include binary or computer executable files. However, the specific type or format of the artifacts in the version control system are not limitations of the invention.

Database 112 is accessed by server 110. Server 110 may be implemented with hardware and software components as are now known or may hereafter be developed. Server 110 may contain computer-readable medium in which a computer program may be stored. Sever 110 may execute the program to perform the desired operations. Server 110 may, for example, be programmed to compress and store versions of files and to retrieve and uncompress files. Server 110 may also be programmed to provide a user interface so that a user may provide files to store in version control system 100 or request files that may be retrieved from version control system 100.

Server 110 is connected over a network 114. Network 114 may be any form of network, such as a LAN or a WAN. Network 114 may be implemented in any suitable technology, whether now known or hereafter developed. Examples of suitable technology include Ethernet, WiFi or SONET. Network 114 allows one or more users to access server 110 to store or retrieve artifacts from database 112.

Users may access server 112 through a plurality of work stations 116₁ . . . 116₄ connected to network 114. Work stations 116₁ . . . 116₄ may each contain a processor and a user interface, such as a display, a keyboard, a mouse or other suitable input/output devices. A human user may enter commands or receive responses through a work station. Commands may cause a new artifact to be stored in database 112 or for an artifact to be retrieved from database 112.

Each work station may also contain computer-readable memory in which one or more programs may be stored. The stored programs may execute on the processor to perform tasks related to the artifacts stored by version control system 100. For example, work stations may execute programs used to edit or compile artifacts representing source code. More generally the work stations may execute programs that generate new artifacts, or new versions of artifacts, to be stored in database 112 or otherwise modify, store, retrieve or otherwise operate on artifacts.

To reduce the amount of computer-readable memory required for database 112, artifacts may be compressed for storage in database 112. In one embodiment, server 110 manages interactions between work stations 116₁ . . . 116₄, including appropriately compressing and uncompressing artifacts as they are stored in or retrieved from database 112. However, artifact compression and uncompression may be performed in any other suitable processor, including on one of the work stations 116₁ . . . 116₄ or an additional processor.

In one embodiment, server 110 is a multitasking processor. It can execute programs as foreground operations or as background operations. Server 110 includes a scheduling mechanism to allocate processor cycles to each task, with foreground tasks given priority in allocation. In this way, foreground tasks are performed more quickly. Operations involving retrieving and uncompressing artifacts from database 112 may be scheduled as foreground tasks. The process of compressing artifacts may be treated as a background operation. As new versions of artifacts are generated for storage, the artifacts may be initially stored in an uncompressed form in database 112, or in any other suitable location. Server 110 may compress the artifacts in the database 112 at a later time when the processing does not disrupt foreground tasks.

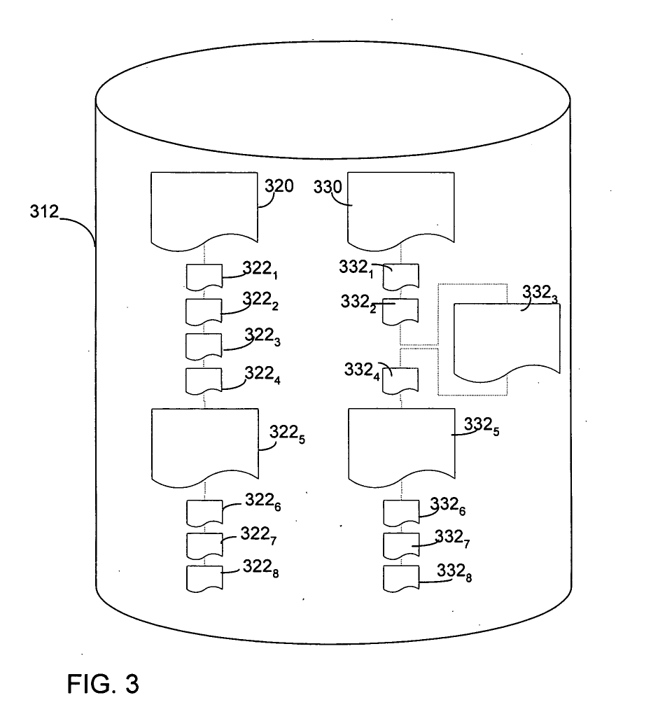

FIG. 2 shows a sketch representing the storage of multiple versions of an artifact within database 112. Artifact 120 represents the most recent version of the artifact. In a version management system, many artifacts are likely stored in database 112. A single artifact is illustrated for simplicity, but a commercial embodiment of a version control system is likely to contain hundreds or thousands of artifacts.

Prior versions of artifact 120 are also stored in database 112. In FIG. 2, prior versions 122₁ . . . 122₄ are shown. Four prior versions are shown for simplicity, but this number is picked for simplicity of illustration. In the illustrated embodiment, the prior versions 122₁ . . . 122₄ are compressed.

In the described embodiment, prior versions are compressed and uncompressed using a compression dictionary. The compression dictionary used for each version includes entries derived from the next later version of the artifact. For example, version 122₁ is compressed with a compression dictionary derived from artifact 120. Version 122₂ uses a compression dictionary derived from version 122₁. This pattern may be used for all prior versions. Accordingly, artifact 120 and prior versions 122₁ . . . 122₄ are shown linked in a chain.

To uncompress a version of an artifact, the chain is followed to recreate the compression dictionary. Artifact 120, at the beginning of the chain, is used to create the compression dictionary for version 122₁. Once version 122₁ is uncompressed, it may be used to create the compression dictionary for version 122₂. Version 122₂ may then be uncompressed, allowing a compression dictionary to be created for uncompressing the next version in the chain.

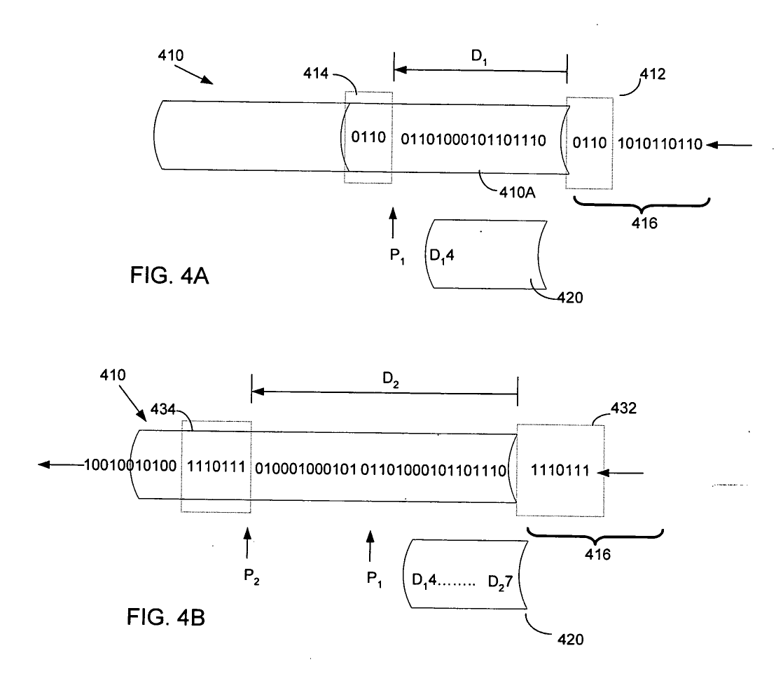

It is not necessary that all prior versions of an artifact be stored in compressed form or be stored using compression that relies on a subsequent version of the artifact. FIG. 3 illustrates an embodiment in which some prior versions of an artifact are stored in uncompressed format. FIG. 3 shows a database 312 that may be part of a version control system. Artifact 320 is stored in database 312 along with prior versions of artifact 320. Eight prior versions, versions 322₁ . . . 322₈, are shown for illustration. Prior version 322₅ is shown stored in uncompressed form.

In the illustrated embodiment, every fifth version of the artifact is stored in an uncompressed form. Substantial compression of the information in database 312 is possible from the compression of most, but not all, of the prior versions. However, the number of prior versions that must be uncompressed to generate any prior version is reduced. For example, retrieving an uncompressed copy of version 322₇ requires that version 322₆ first be uncompressed. Because prior version 322₅ is stored in uncompressed form and is available to uncompress version 322₆, no additional prior versions must be uncompressed. Were version 322₅ not stored in uncompressed form, versions 322₁ . . . 322₆ would additionally need to be uncompressed. The time required to access version 322₇ is reduced by the time required to uncompress versions 322₁ . . . 322₅, which could be a significant time savings.

As more prior versions are stored, the position of the uncompressed versions in the sequence of prior versions may change. For example, if a new version is added, version 322₅ will become the sixth version. If every fifth version is to be stored in uncompressed form, version 322₄, which became the fifth prior version in the sequence when a new version was added, may be uncompressed and then used to compress 322₅, which is no longer the fifth prior version. Uncompressing prior version 322₄ and compressing of version 322₅ may be done as a background task.

Alternatively, the version to be stored in uncompressed form may be determined by counting from the oldest version. For example, if every fifth version is to be stored in uncompressed form, the fifth version stored will not be compressed, even when later versions are stored. When five more versions are added, the tenth version of the file may be stored without compression. Selecting prior versions to store in this fashion avoids the need to compress and uncompress versions as new versions are added.

Any suitable approach may be used to select which versions should be stored in uncompressed form. Artifact 320 provides an example of storing an artifact in which a prior version of the artifact is stored in uncompressed form at a predetermined interval in the sequence of prior versions. In an alternative embodiment, prior versions to store in uncompressed form may be selected adaptively instead of or in addition to prior versions at predetermined intervals.

An example of another way of determining which versions to store in uncompressed form is also provided in FIG. 3. In this example, versions to store in uncompressed form are selected based on activity level. In FIG. 3, artifact 330 is shown stored along with prior versions 332₁ . . . 332₈. The fifth prior version is stored in uncompressed form in the same way that the fifth prior version of artifact 320 was stored. In addition, prior version 332₃ is also stored in uncompressed form. In this embodiment, prior version 332₃ is selected to be stored in uncompressed form based on activity level.

Prior version 332₃ represents a prior version for which activity in accessing that prior version is used to select the prior version for storage in uncompressed form. Various methods of selecting prior versions based on activity level are possible, and any suitable method may be used. For example, database 312 may contain some number of storage locations dedicated to storing uncompressed versions, similar in concept to a cache. As each version is accessed, it may be stored in one location in the “cache.” Once all of the cache locations are full and a new uncompressed version is to be retained, one of the stored versions in the cache may be overwritten. Any suitable policy for selecting which location to overwrite may be used. For example, a location to overwrite may be selected by identifying the oldest version in the cache, or by identifying the least frequently accessed version stored in the cache or the least recently accessed version.

As another alternative, versions may be selected for storage in uncompressed form based on the number of accesses to that version. In such an embodiment, version 322₃ may represent a prior version that is accessed frequently.

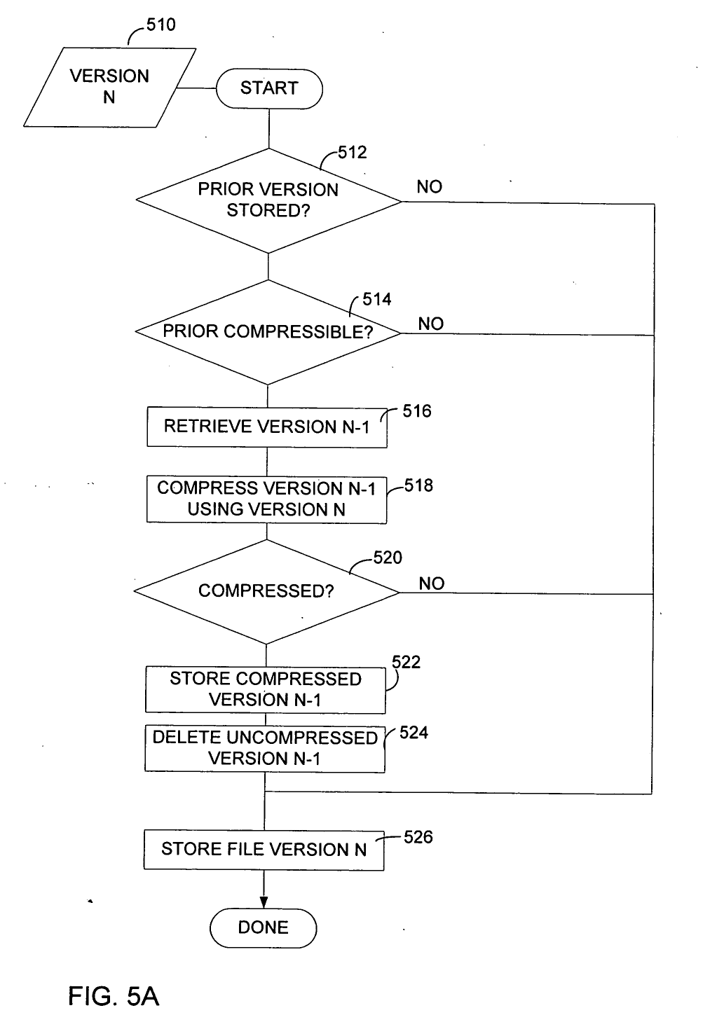

Turning now to FIG. 4, a process for compressing a prior version of an artifact is illustrated. A modified form of the LZ77 compression algorithm may be used for compressing prior versions. Alternatively, a compression algorithm as described in any of U.S. Pat. Nos. 6,496,974; 6,466,999; 6,449,764; 6,243,766; and 6,216,175, which are hereby incorporated by reference in their entireties for all purposes, may be used.

In this example, processing is performed using a buffer 410. The contents of buffer 410 serve as a “compression dictionary.” Strings of characters in the file to be compressed are represented by correspondence to the strings of characters in the compression dictionary.

Buffer 410 may be implemented in any computer-readable and computer-writable media in the processor performing the compression. In the illustrated embodiment, the buffer 410 is memory in server 110 (FIG. 1), but the processing may be performed in any suitable processor using any suitable memory. The size of buffer 410 is not critical to the invention. For example, the buffer may be on the order of 32 Kbytes. For artifacts larger than 32K, larger buffers may provide greater compression, but smaller buffers may reduce processing time. Accordingly, buffers between about 1K to 256 K will be used in some embodiments.

At the outset of the process, buffer 410 is loaded with the newer version of the artifact to be compressed. In the example of FIG. 3, to form the compressed version 322₁, artifact 320 is the newer version loaded in buffer 410. In the illustrated embodiment, the newer version of the artifact occupies buffer portion 410A.

The prior version of the artifact is used to generate a stream of characters 416. In its simplest form, each character may be simply a 1 or a 0. For simplicity of illustration, a stream of bits is shown. Alternatively, the characters may be bytes, so that the stream of 1's and 0's may be treated as a stream of bytes or as a stream of characters of any other desired length. Any suitable type of character may be used.

The characters of the prior artifact are processed sequentially in strings. As each character is processed, it is shifted into one side of buffer 410. When enough characters of the version being compressed have been shifted into buffer 410, the characters representing the newer version used to preload buffer 410 are shifted out the other side. Once shifted out of buffer 410, the characters are not used in the compression dictionary.

The characters of the artifact being compressed are processed by matching strings of characters in stream 416 to strings of characters in buffer 410. For example, string 412 in stream 416 matches string 414 in buffer 410.

Upon selecting a match, an indication of the matching string is made in compressed artifact 420. In this example, the indication of the matching string is provided as an offset from the start of the buffer and a string length. In this example, an indication represented as D₁4 is added to compressed artifact 420. D₁ indicates the offset from the start of the buffer where matching string 414 begins. The numeral 4 indicates the number of characters in the string matched.

As successive matches are found, further indications are added to compressed artifact 420. FIG. 4B shows the compression process at a later state. In the state pictured, characters are being shifted out of buffer 410 as new characters in stream 416 are shifted in. Buffer 410 contains characters from the subsequent version of the artifact initially loaded into buffer 410 and from the version of the artifact being compressed.

In the state shown in FIG. 4B, string 432 in stream 416 matches string 434 in buffer 410. String 434 is offset from the beginning of the buffer by an amount D₂ and has a length of 7 characters. Accordingly, the code D₂7 is added to compressed artifact 420. The process of matching strings at the beginning of stream 416 to strings in buffer 410 may continue in this fashion until all characters in stream 216 are matched. When all characters in stream 416 are processed, the compressed artifact 420 will contain a compressed version of the prior version of the artifact. The compressed version of the file contains all information required to recreate the uncompressed file, indicating that the compression process provides lossless compression.

Matching strings may be found in any suitable way. One search process may involve comparing the first character in stream 416 to each character in buffer 410. When the first character in the stream 416 matches a character in the buffer 410, successive characters in stream 416 may be compared to successive characters in buffer 410 to determine the length of the strings that can be matched. Similar comparisons may be made for every character in buffer 410 to determine the longest possible string at the beginning of stream 416 that can be matched to a string in buffer 410.

As an alternative to searching for a matching string at any point in buffer 410, the search for a matching string may be limited to a region or regions in the buffer 410. In the illustrated embodiment, two pointers, P₁ and P₂ are shown. Each pointer indicates the location in buffer 410 where a matching string was found. The search for a matching string may be limited to regions in buffer 410 within a specified distance of one of the pointers. Each time a new matching string is found, one of the pointers may be reset to point to the location of the matching string.

The number of pointers used and the size of the regions around the pointers searched for matching strings may be varied based on the statistical properties of the artifacts being compressed. But, as one example, three pointers may be used and the search for matching strings conducted in a 2K region around each pointer.

Where the size of the newer version of the artifact is larger than buffer 410, the beginning portion of the artifact is loaded into buffer 410 until the buffer is full. Any additional portions of the newer version of the artifact may be omitted entirely from the compression dictionary. Alternatively, buffer 410 may be divided into two portions, each acting as a buffer. A first portion may be dedicated to buffering a portion of the newer version of the file and a second portion may be dedicated to buffering a portion of the version of the artifact being compressed. Characters of the stream formed from the version of the artifact being compressed are shifted into the second portion. As new characters in stream 416 are shifted into the second portion of the buffer, others are shifted out of the buffer and no longer form a portion of the compression dictionary. As new characters from the stream 416 are shifted into one portion of the buffer, an equal number of new characters from the newer version of the artifact may be shifted into and displace characters in the first portion of the buffer. In this way, the compression dictionary in buffer 410 contains portions of both the artifact being compressed and the newer portion of the artifact, regardless of the size of the artifact.

A similar process is performed in reverse to uncompress the artifact. The compression dictionary is recreated by loading buffer 410 with the newer version of the artifact used for compression. The indications of the strings stored in compressed artifact 420 are used to locate strings in the compression dictionary. As strings are located, they are added to the uncompressed file. The strings are also used to create a stream of values shifted into the buffer to duplicate the effect of shifting stream 416 into buffer 410 during the compression process. In this way, the compression dictionary at the time of uncompressing tracks the compression dictionary used during compression.

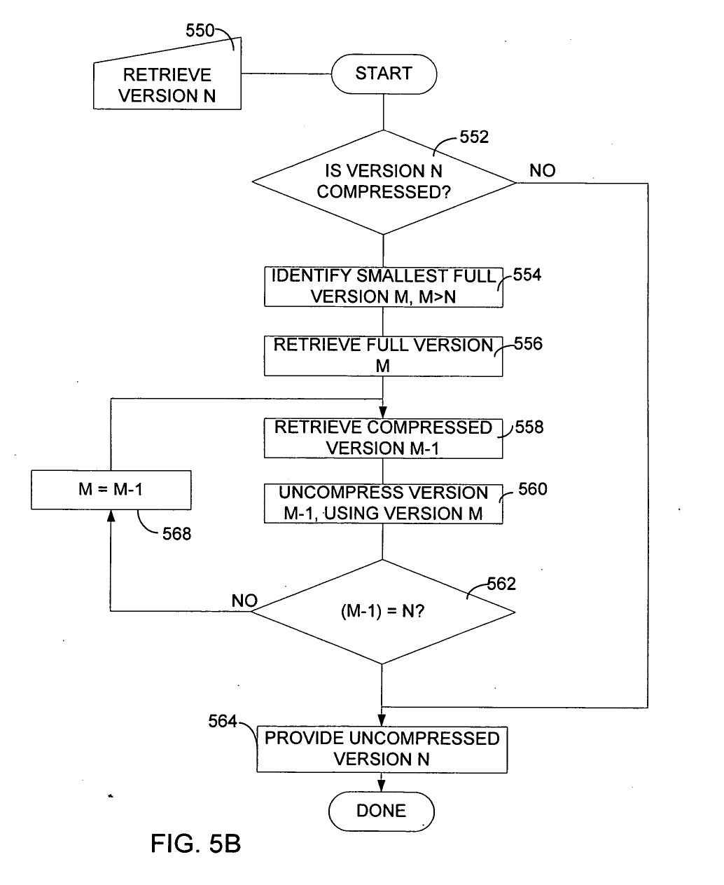

Turning now to FIG. 5A, a process of storing an artifact in version management system 100 is shown. At block 510, a version N of the artifact is provided as an input to the process. The input may, for example, be provided in response to a human user entering a command at one of the work stations 116₁ . . . 116₄ or may be generated by a software tool or may be generated in some other way.

Regardless of the source of version N, the process continues to decision block 512. At decision block 512, a determination is made of whether the version control system stores a prior version of the artifact. If no prior version of the artifact is stored, processing proceeds to block 526 where the version N is stored. At block 526, version N is stored in an uncompressed form.

Where a prior version is stored, processing proceeds from decision block 512 to decision block 514. At block 514, a determination is made whether the prior version is compressible. A version of an artifact may be deemed to be not compressible for any of a number of reasons. For example, if the artifact contains characters that are so random that insufficient connection can be found to the entries in the compression dictionary, the compression process may be ineffective. Alternatively, the prior version may represent a version that will be retained in an uncompressed state as discussed above in connection with FIG. 3.

If the prior version of the artifact is deemed to be not compressible, processing again proceeds to block 526 where the version N of the artifact is stored in an uncompressed format.

Where the prior version is compressible, the processing proceeds from decision block 514 to block 516. At block 516a prior version of the artifact is retrieved for compression. Here, the immediately preceding version of the artifact is selected for compression.

At block 518, the prior version of the artifact, here designated version N−1, is compressed using version N. In this embodiment, version N−1 is compressed using a version of the LZ77 compression process or as described above. Accordingly, version N is used to create the initial compression dictionary.

Processing then proceeds to decision block 520. At decision block 520, a determination is made whether the compression process at block 518 has resulted in a compressed file that is smaller than the original. If not, processing proceeds to block 526 without storing the compressed version. In this scenario, version N−1 is left in an uncompressed state.

If compression has reduced the size of the version N−1, processing proceeds to block 522. At block 522, the compressed version N−1 is stored. The uncompressed version is deleted at 524. In this way, the compressed version replaces the uncompressed version in version control system 100.

The process then continues to block 526 where the uncompressed version N is stored.

If the process depicted in FIG. 5A is followed for each version of an artifact to be added to version control system 100, version control system will contain the most recent version of each artifact in an uncompressed form. Other versions of the artifact may be stored in compressed form or uncompressed form.

The process for retrieving an artifact from version control system 100 is illustrated in FIG. 5B. The process begins at block 550 with an input to retrieve a version N of an artifact. The input may come from a human user or may come from a software tool or form any other source.

Processing starts at decision block 552. At decision block 552, a determination is made whether the requested version of the artifact is stored in a compressed form. If not, processing proceeds to block 564 where the uncompressed version N is provided.

If the requested version N is compressed, processing continues to block 554. At block 554, an uncompressed version of the file is selected to initialize the buffer for uncompression. In this embodiment, the version of the artifact that requires the fewest passes through the uncompressing process is selected. A later version of the artifact is selected. The uncompressed version that is closest to the compressed version in the chain of versions is selected. That version is denoted as version M, with M being a version number of an uncompressed version. In this scenario, M is selected to be the smallest version number of an uncompressed artifact larger than N.

At block 556, the uncompressed version M is retrieved from database 112 (FIG. 1). At block 558, the next version of the artifact, here denoted version M−1, is retrieved. This version is stored in compressed form.

At block 560, the uncompressed version M and the compressed version M−1 of the artifact are processed to uncompress version M−1. Version M−1 may be uncompressed using the inverse of the compression process used in storing the compressed versions.

The process then proceeds to decision block 562. If (M−1) equals N, the version of the file uncompressed at block 560 is the requested version N. Processing then proceeds to block 564 where this uncompressed version is provided as the requested output. If (M−1) does not equal N, processing loops back through block 568.

At block 568, the value of M is decremented. Decrementing M makes the version of the file uncompressed in the prior iteration version M in the next iteration. That version is then used to uncompress the next version of the artifact.

The process iterates in this fashion until the requested version N is retrieved and uncompressed.

Having thus described several aspects of at least one embodiment of this invention, it is to be appreciated that various alterations, modifications, and improvements will readily occur to those skilled in the art.

For example, FIG. 3 illustrates selected versions in the chain of successive versions are stored in uncompressed form. The uncompressed versions may be stored in stead of or in addition to the compressed representations of the version.

As another example, various types of artifacts may be stored in a version control system. Because a compression process used herein does not depend on the artifact being compressed to have a recognizable end-of-line character, the same system may be used to store multiple types of files. For example, text files and binary files may be stored by the same system.

Such alterations, modifications, and improvements are intended to be part of this disclosure, and are intended to be within the spirit and scope of the invention. Accordingly, the foregoing description and drawings are by way of example only.

The above-described embodiments of the present invention can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or conventional programming or scripting tools, and also may be compiled as executable machine language code.

In this respect, the invention may be embodied as a computer readable medium (or multiple computer readable media) (e.g., a computer memory, one or more floppy discs, compact discs, optical discs, magnetic tapes, etc.) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The term “program” is used herein in a generic sense to refer to any type of computer code or set of instructions that can be employed to program a computer or other processor to implement various aspects of the present invention as discussed above. Additionally, it should be appreciated that according to one aspect of this embodiment, one or more computer programs that when executed perform methods of the present invention need not reside on a single computer or processor, but may be distributed in a modular fashion amongst a number of different computers or processors to implement various aspects of the present invention.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiment.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method of operating a version control system storing a plurality of versions of an artifact including at least a first version of the artifact and a second version of the artifact, each of the first version and the second version comprising strings of data, the method comprising:
a) forming a compressed representation of the first version of the artifact by:
i) forming a compression dictionary comprising strings of data from the first version of the artifact and the second version of the artifact;
ii) for each of a plurality of strings of data in the first version of the artifact, matching the string of data to a matching string of data in the compression dictionary;
iii) for each string of data in the first version of the artifact matched to a matching string of data in the compression dictionary, including in the compressed representation an indication of the matching string of data; and
b) storing the second version of the artifact and the compressed representation of the first version.

2. The method of claim 1, wherein including in the compressed representation an indication of the matching string of data comprises including in the compressed representation a value related to the size of the matching string of data and a value related to the position of the matching string of data within the compression dictionary.

3. The method of claim 1, wherein the method is performed on a processor executing foreground and background tasks and the method additionally comprises performing one or more foreground tasks and forming a compressed representation of the first version of an artifact is performed as a background task.

4. The method of claim 3, wherein performing one or more foreground tasks comprises retrieving a version of an artifact in response to a user request.

5. The method of claim 1, wherein:
a) forming a compression dictionary comprises loading in a buffer at least a portion of the first version of the artifact and at least a portion of the second version of the artifact; and
b) matching the string of data to a matching string of data in the compression dictionary comprises matching the string of data to a matching string of data in the buffer.

6. The method of claim 5, wherein including in the compressed representation an indication of the matching string of data comprises storing an indication of the position in the buffer of the matching string of data.

7. The method of claim 5, wherein the method additionally comprises shifting into the buffer a second portion of the first version of the artifact.

8. The method of claim 5, wherein:
a) the string comprises a plurality of character and the buffer stores a plurality of characters;
b) the method additionally comprises maintaining at least one pointer to a character in the buffer;
c) matching the string of data to a matching string of data in the buffer comprises comparing characters in the string to characters in the buffer based on their relationship to the character pointed to by the pointer; and
d) the method additionally comprises, upon selecting a matching string in the buffer, adjusting the at least one pointer based on the position of the matching string in the buffer.

9. The method of claim 1, additionally comprising recreating the first version of the artifact from the compressed representation by:
i) recreating the compression dictionary using the second version of the artifact;
ii) using an indication in the compressed representation to select a string from the compression dictionary; and
iii) using the string to update the compression dictionary and in the first version of the artifact.

10. A method of operating a version control system storing representations of a plurality of files, including a text file that has a format defining lines of text and a binary file, with the version control system storing at least a first version of the text file and a second version of the text file and a first version of the binary file and second version of the binary file, the method comprising:
a) forming a compressed representation of the first version of the text file using a predetermined compression process that is independent of the format of the first version of the text file;
b) forming a compressed representation of the first version of the binary file using the predetermined compression process; and
c) storing the compressed representation of the first version of the binary file and the compressed representation of the first version of the text file.

11. The method of claim 10, wherein the predetermined compression process comprises matching stings of data in a file to be compressed with strings of data in a subsequent version of the file.

12. The method of claim 10, wherein the predetermined compression process comprises applying an LZ compression algorithm.

13. The method of claim 10, wherein operating a version control system comprises operating a version control system in a software development environment and forming a compressed representation of the first version of the binary file comprises forming a compressed representation of a version of a computer executable file and forming a compressed representation of the first version of the text file comprises forming a compressed representation of a version of a source code file.

14. The method of claim 10, wherein:
a) the first version and the second version of the binary file comprise characters that may be formed into strings; and
b) forming a compressed representation of the first version of the binary file comprises:
i) creating, using the second version of the binary file, a compression dictionary comprising characters; and
ii) matching strings of characters in the first version of the binary file to characters in the compression dictionary.

15. A version control system for storing a plurality of successive versions of an artifact, the version control system having computer-readable medium having stored thereon data structures representing:
a) for each version of the artifact in a first portion of the plurality of successive versions of the artifact, a compressed representation comprising an indication of at least a portion of a successive version of the artifact;
b) a first uncompressed representation of a first selected version of the plurality of successive versions, the first selected version succeeding the versions of the artifact in the first portion of the plurality of successively created versions;
c) for each version of the artifact in a second portion of the plurality of successive versions of the artifact, the versions of the artifact in the second portion succeeding the first selected version, a compressed representation comprising an indication of a portion of a successive version of the artifact; and
d) a second uncompressed representation of a second selected version of the plurality of successive versions, the second selected version succeeding the versions in the second portion of the plurality of successive versions of the artifact.

16. The version control system of claim 15, additionally comprising computer-executable instructions stored on the computer-readable medium, the computer-executable instructions performing the steps of:
a) receiving an input identifying a requested version of the artifact, the requested version being stored in the computer-readable medium as a compressed representation;
b) selecting the first selected version or the second selected version based on which is after the requested version and closer to the requested version in the succession of versions in the plurality of successive versions of the artifact; and
c) using the uncompressed representation of the selected version to uncompress a compressed representation of a version of the artifact.

17. The method of claim 16, wherein the computer-executable instructions additionally perform the step of using the uncompressed representation of the artifact to uncompress a second compressed representation of a version of the artifact.

18. The method of claim 15, wherein the first selected version has a predetermined position within a succession associated with the plurality of successive versions.

19. The method of claim 15, wherein the first selected version has a position within a succession associated with the plurality of successive versions selected based on an activity level associated with the first version.

20. The method of claim 15, wherein the first selected version is stored in a cache.
